(19) United States
(12) Patent Application Publication
(10) Pub. No.: US 2018/0365555 A1
(43) Pub. Date: Dec. 20, 2018

(54) ARTIFICIAL INTELLIGENCE BASED ALGORITHM FOR PREDICTING PIPELINE LEAK AND CORROSION DETECTION

(71) Applicant: Naveed Aslam, Bellaire, TX (US)

(72) Inventor: Naveed Aslam, Bellaire, TX (US)

(21) Appl. No.: 15/840,535

(22) Filed: Dec. 13, 2017

Related U.S. Application Data
(60) Provisional application No. 62/437,716, filed on Dec. 22, 2016.

(51) Int. Cl. G06N 3/04; G06N 3/08; F17D 5/00

(52) U.S. Cl. CPC G06N 3/0436; F17D 5/00; G06N 3/084; G06N 3/086

(57) ABSTRACT

A method for predicting corrosion in a pipeline wherein the pipeline is subject to corrosion by the steps of obtaining data of parameters associated with the pipeline, comparing the data against previously generated data of parameters associated with the pipeline, and calculating, based on differences between the data with the previously generated data the probability of corrosion in the pipeline. The calculation can be performed using a variety of algorithms and modeling methods.

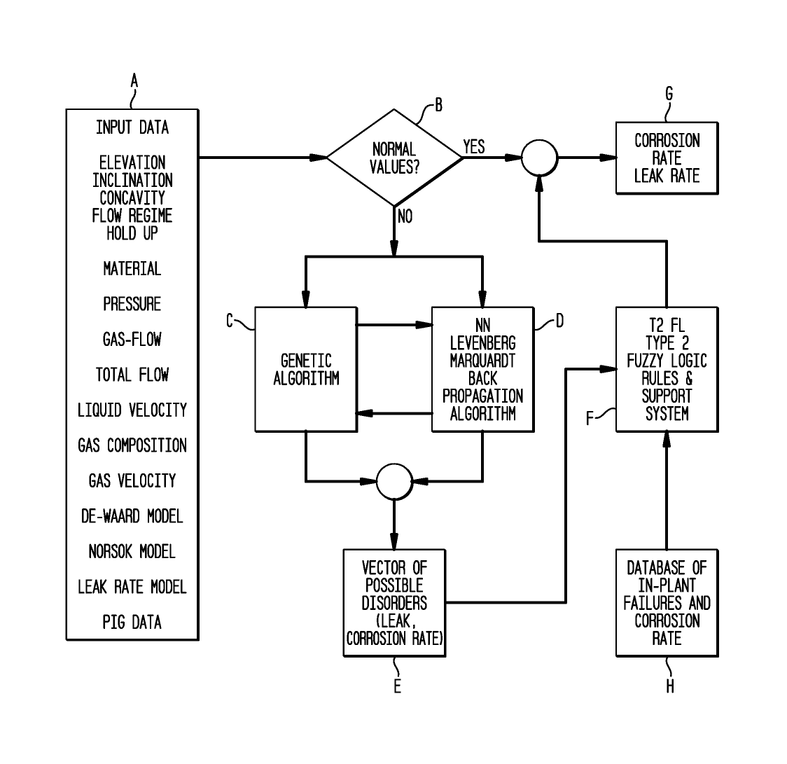

### CROSS REFERENCE TO RELATED APPLICATIONS

This application claims priority from U.S. provisional patent application 62/437,716 filed on Dec. 22, 2016

### BACKGROUND OF THE INVENTION

The present invention relates to an Artificial Intelligence (Al) based algorithm for the detection and prediction of pipeline leaks and corrosion.

Natural gas is a growing industry and is rapidly replacing oil and coal as a cleaner and lower cost fuel. The shale revolution has boosted the importance of natural gas to the energy landscape, particularly in the US. However, the natural gas delivery infrastructure is aging and deteriorating. The US Department of Energy has emphasized that having a reliable natural gas delivery system is one of the critical needs for ensuring the growth and function of the energy sector. There are approximately 650 thousand miles of delivery pipelines current in existence in the US. Timely detection of failures, caused by corrosion or leaks is a critical element of ensuring the reliability of the natural gas delivery systems.

There is a need for improvements in the field of detecting and predicting natural gas pipeline leaks or failures, in order to increase the stability and reliability of the pipeline infrastructure.

### SUMMARY OF THE PRESENT INVENTION

The invention provides a method for predicting corrosion along the length of a pipeline as well as corresponding leak profiles. The current prediction methods provide only a generalized corrosion average for the pipeline as a whole, but do not provide accurate or detailed information for specific problem areas. The invention overcomes this problem and provides a more complete predictive model that distinguishes different sites along the pipeline length and highlights those locations along the pipeline that have higher and lower chance of corrosion and ultimate failure. This results in a more precise model that enables proactive maintenance of the pipeline and thereby increases reliability while lowering the cost of operation.

In a first embodiment of the invention, there is disclosed a method for predicting corrosion in a pipeline wherein the pipeline is subject to corrosion comprising the steps of obtaining data of parameters associated with the pipeline, comparing the data against previously generated data of parameters associated with the pipeline, and calculating, based on differences between the data with the previously generated data the probability of corrosion in the pipeline. The probability of corrosion is typically for a location along the pipeline.

The pipeline will typically contain a hydrocarbon selected from the group consisting of liquid hydrocarbons and natural gas.

The data of parameters associated with the pipeline are selected from the group consisting of external stresses and internal stresses. The external stresses are selected from the group consisting of elevations, inclinations, weather patterns, external temperatures. The internal stresses are selected from the group consisting of hydrocarbon composition, gas composition, pressure, flow rates, fluid and gas and hydrocarbon velocities.

The predicting of the probability of corrosion in the pipeline is performed by an artificial intelligence algorithm. The previously generated data of parameters is continuously updated for the pipeline. The artificial intelligence algorithm is a continuously updated predictive model.

The artificial intelligence algorithm is selected from the group consisting of De-Waard Model, Norsok Model and the Leak Rate Model.

If the data of parameters associated with the pipeline is consistent with previously generated data of parameters associated with the pipeline, then this is a normal condition and corrosion and leak rates are predicted using a deterministic model such as the De-Waard Model.

If the data of parameters associated with the pipeline is not consistent with previously generated data of parameters associated with the pipeline then this is a learning condition and corrosion and leak rates are predicted based upon a generic algorithm.

The generic algorithm interacts with an artificial neural network in a continuous manner to generate the prediction of leaks and corrosion rates in the pipeline.

The predictions are further refined in a fuzzy logic subroutine algorithm. The fuzzy logic subroutine algorithm is a type 2 fuzzy logic system. The type 2 fuzzy logic system comprises fuzzification, a fuzzy inference process and defuzzification.

During normal operation, oil and gas pipelines are subjected to both internal and external stresses, including varying environments and different flow compositions. This leads to varying corrosion rates and leak sites at different locations along the pipeline. It is difficult to get an accurate assessment of actual corrosion rates and leak rates because there are so many uncertainties and different measurement techniques used. The often results in a false prediction based on ineffective methodology which lowers reliability.

To overcome these problems and provide a more accurate predictive method, the method of the invention takes into consideration a number of measured parameters associated with the pipeline and then compares these measurements against past data to predict the probability of corrosion and potential leakage sites.

An important aspect of the method of the invention is that it is based on an Al algorithm. This makes the predictive function more accurate and reliable because the past data used for comparison is updated on a continuous basis as additional data and experience is obtained. Therefore, the method of the invention provides a continuously updated predictive model and provides better and continuously improving reliability standards.

As noted, there are numerous stresses on a pipeline that can change corrosion rates and corresponding leak sites along the length of the pipeline. These stresses may be external, such as environmental differences, or internal, such as compositional differences of the pipeline materials or of the material being transported. Different environments are generally related to the physical location of the pipeline and may result from different elevations, inclinations, general weather patterns, temperatures, etc. The material differences can include gas composition, pressure, flow rates, fluid and gas velocities, etc.

### BRIEF DESCRIPTION OF THE DRAWINGS

The Figure is a flow chart showing the data and previously generated data being evaluated by various algorithmic parameters to compare differences.

### DETAILED DESCRIPTION OF THE INVENTION

It is these differences as well as others that can be measured according to the invention and provide the data upon which predictions are made. Therefore, according to the method of the invention, data such as that noted above is gathered. This gathered data is then compared to known data and the comparison is used to predict the areas along the pipeline where corrosion rates may be elevated and that might result in leaks sites.

A number of modeling methods may be used to perform the comparison. These modeling methods include the De-Waard Model, the Norsok Model and the Leak Rate Model. The model of De-Waard & co-workers was developed based on carbon dioxide corrosion prediction in pipelines. For many years this was the only and most widely used model for the prediction of worst case scenario of carbon dioxide transport. This model is based on empirical fitting of laboratory experimental data and has been revised several times in the last 25 years as new information became available. Several different correction factors have been added to the original equation for different possible scenarios of materials and presence of moisture, PH, corrosion products and oil/liquid wetting. This model does not account for the use of protective corrosion films. Several Operating & Oil & Gas companies have created adaptations of this model and are actively using it in the field for making predictions such as BPs' Cassandra tool. Though this is a good first line model, the performance in predicting corrosion is not very satisfactory.

For example, during the process of internal corrosion direct assessment (ICDA) processing of seven pipelines, the commonly used De-Waard 95 model failed to predict the corrosion rate for 74.3% of excavation points. So 86 out of 116 excavation points yielded an absolute error greater than 0.05 mm/yr. Similarly, the Norsok M-506 model is an empirical model developed by Norwegian Oil company StetOil. This model is fitted to a large amount of laboratory data and provides a predictive equation for the assessment of corrosion. This model extends the range of predictions and can be used for higher temperatures (150° C.) and higher PH values. But like the De-Waard model, it has serious limitations in predicting corrosion along the pipeline.

The leak rate models are based on accounting for a multitude of phenomenon in the transport of hydrocarbons such as diffusion theory, fluid mechanics, numerical methods, medium flow state as well the characteristics and nature of leakage holes or spots. These different underlying transport phenomena are modeled and solved through appropriate numerical methods. For example, a hole-tube integrated model has been used to predict the media leakage rate for long-distance NG pipelines. These models are used for risk assessment and integrity management of onshore pipelines but they have serious limitations as far accuracy and reliability is concerned. Therefore, operators are forced to use other available methods like pigging, LDAR, etc., for ensuring a proper risk assessment and integrity management.

The invention can also be explained with reference to the Figure, which shows a schematic representation of the method. As shown, the input from one or more sources as listed in the Input Data box of the Figure are initially gathered. The physical data may be gathered from sensors or the like deployed along the length of the pipeline. The gathered data is then compared to past known data stored for example in a database. If the gathered data is “normal” meaning that the data is consistent with past data points, then corrosion rates and leak rates can be predicted by using know deterministic models, such as the De-Waard model.

However, if the gathered data is not consistent with the past data from the database, then the method of the invention utilizes a learning network in order to update the database and thereby increase the reliability and predictability for the system. The Figure shows the proposed architecture and method to predict corrosion and leak rates according to the invention.

In the method according to the invention, inputs from sensors as well currently employed deterministic models to make predictions are received. The inputs are compared with a deviation filter which is the initiation point for the AA approach. If values are in normal range the AA scheme will not be initiated, but if abnormal deviations are detected, a screening subroutine will start the computational sequence of inventive process. At the heart of this process is an Artificial Neural Network (ANN, alternatively NN) that is composed of a number of neuron layers. The basic or input layer is fed with selected input variables which are then passed into the hidden layers in which the processing will take place. For example, algorithms such as the Levenberg-Marquardt or Back-Propagation algorithms may be applied. The processing takes place in these hidden layers and as output is generated the last hidden layer communicates the results to an external source which generates an output vector of possible disorders such as difference in leak rates, corrosion rates, pressures, flow rates etc.

The performance of the ANN is dependent upon the number of layers, the number of neurons in each layer, the weights between the related neurons and threshold. These parameters are obtained through subsequent training of the ANN system. The training of an ANN system is a complex task and could lead to predictions which are not relevant. Therefore, according to the invention, the parameters are computed by an intelligent optimization algorithm of evolutionary origin, for example, a Genetic Algorithm (GA).

The constant interaction of the GA with the ANN system ensures minimization of error and more realistic computation of parameters required for the ANN system. The output from this hybrid system provides the leak and corrosion rates along the pipeline. This output may be sent directly to an operator to make decisions about risks and asset integrity. However, according to the invention, in order to further refine the predictions, a Fuzzy logic subroutine is activated and data is further scrutinized for better and crisper predictions. This can be carried out using a T2FL (type 2 fuzzy logic system). The T2FL system is made up of a Fuzzifier, a Rule based inference engine and output processor. Therefore, the system integrates the experience and knowledge of very experienced human pipeline operators/experts into the parameters associated with the rule base and membership functions. This helps less experienced operators with key decision making processes.

The fuzzy logic system can be thought of as an average human beings' feelings and inference processing. The fuzzy logic system or strategy is a range-to-point or range-to-range control that differs from the standard control theory of point-to-point control. The output of a fuzzy controller is derived from fuzzifications of both inputs and outputs using the associated member functions. A crisp input will be converted into different members of associated member functions, which than is processed as a range of inputs. The fuzzy logic system implemented by the invention here has three main components.

Fuzzification: Conversion of classical data or crisp data into fuzzy data or membership function;

Fuzzy Inference Process: Combines membership functions with rules to derive the fuzzy output;

Defuzzification: Uses different methods to compute each associated output and puts them into a lookup table, with the process then picking an output from the lookup table based on current inputs from the ANN system.

The output from the method of the invention may be used to predict corrosion rates and possible specific leak sites along a pipeline. This then allows more accurate preventive maintenance to be performed that can serve to avoid an actual leak from occurring. The method of the invention therefore provides a way of preventing leaks from occurring. This then results in significant cost savings as well as avoiding additional issues that can arise if a leak occurs, e.g. environmental pollution, loss of natural gas, shut down and repair costs, etc.

It is anticipated that other embodiments and variations of the present invention will become readily apparent to the skilled artisan in the light of the foregoing description, and it is intended that such embodiments and variations likewise be included within the scope of the invention as set out in the appended claims.

What I claim is:

1. A method for predicting corrosion in a pipeline wherein the pipeline is subject to corrosion comprising the steps of obtaining data of parameters associated with the pipeline, comparing the data against previously generated data of parameters associated with the pipeline, and calculating, based on differences between the data with the previously generated data the probability of corrosion in the pipeline.

2. The method as claimed in claim 1 wherein the pipeline contains a hydrocarbon selected from the group consisting of liquid hydrocarbons and natural gas.

3. The method as claimed in claim 1 wherein the data of parameters associated with the pipeline are selected from the group consisting of external stresses and internal stresses.

4. The method as claimed in claim 3 wherein the external stresses are selected from the group consisting of elevations, inclinations, weather patterns, external temperatures.

5. The method as claimed in claim 3 wherein the internal stresses are selected from the group consisting of hydrocarbon composition, gas composition, pressure, flow rates, fluid and gas and hydrocarbon velocities.

6. The method as claimed in claim 1 wherein the probability of corrosion is for a location along the pipeline.

7. The method as claimed in claim 1 wherein the predicting of the probability of corrosion in the pipeline is performed by an artificial intelligence algorithm.

8. The method as claimed in claim 1 wherein the previously generated data of parameters is continuously updated for the pipeline.

9. The method as claimed in claim 7 wherein the artificial intelligence algorithm is a continuously updated predictive model.

10. The method as claimed in claim 7 wherein the artificial intelligence algorithm is selected from the group consisting of De-Waard Model, Norsok Model and the Leak Rate Model.

11. The method as claimed in claim 10 wherein if the data of parameters associated with the pipeline is consistent with previously generated data of parameters associated with the pipeline then this is a normal condition and corrosion and leak rates are predicted using a deterministic model.

12. The method as claimed in claim 1 wherein if the data of parameters associated with the pipeline is not consistent with previously generated data of parameters associated with the pipeline then this is a learning condition and corrosion and leak rates are predicted based upon a generic algorithm.

13. The method as claimed in claim 12 wherein the generic algorithm interacts with an artificial neural network in a continuous manner to generate the prediction of leaks and corrosion rates in the pipeline.

14. The method as claimed in claim 12 wherein the predictions are further refined in a fuzzy logic subroutine algorithm.

15. The method as claimed in claim 12 wherein the fuzzy logic subroutine algorithm is a type 2 fuzzy logic system.

16. The method as claimed in claim 12 wherein the type 2 fuzzy logic system comprises fuzzification, a fuzzy inference process and defuzzification.

17. The method as claimed in claim 11 wherein the deterministic model the De-Waard Model.
